(19) United States
(12) Patent Application Publication
(10) Pub. No.: US 2024/0053168 A1
(43) Pub. Date: Feb. 15, 2024

(54) MAPPING METHOD FOR ROBOT, ROBOT AND COMPUTER-READABLE STORAGE MEDIUM

(71) Applicant: UBTECH ROBOTICS CORP LTD, Shenzhen (CN)

(72) Inventors: YONGSHENG ZHAO, Shenzhen (CN); Yu Tang, Shenzhen (CN)

(21) Appl. No.: 18/232,791

(22) Filed: Aug. 10, 2023

(30) Foreign Application Priority Data
Aug. 12, 2022 (CN) 202210970258.9

(51) Int. Cl. G01C 21/00

(52) U.S. Cl. CPC G01C 21/3837

(57) ABSTRACT

A mapping method for a robot includes: detecting a plurality of linear trajectories of the robot in a process of building a map; inserting a positioning key frame corresponding to each of the linear trajectories, wherein the positioning key frame comprises, when the robot is located on a corresponding one of the linear trajectories, a first pose in a positioning coordinate system, and a second pose in a map coordinate system; and for each two adjacent ones of the linear trajectories, according to one of the first poses determined according to a displacement between the positioning key frames of the two adjacent ones of the linear trajectories, performing optimization of loop closure constraints on the second poses of the positioning key frames, and generating a map based on the optimized positioning key frames.

### CROSS REFERENCE TO RELATED APPLICATIONS

The present application claims priority to Chinese Patent Application No. CN202210970258.9, filed Aug. 12, 2022, which is hereby incorporated by reference herein as if set forth in its entirety.

### TECHNICAL FIELD

The present disclosure generally relates to robots, and particularly to a mapping method for a robot, robot and computer-readable storage medium.

### BACKGROUND

When a robot navigates in a large scene, it usually needs to use sensors such as single-line lidar, multi-line lidar, or camera, RGB camera as a mapping device to build a scene map. Due to the limited detection distance of the sensors, it tends to fail to detect stationary objects such as surrounding walls in an open area in a large scene, and the robot cannot be positioned accurately.

In order to facilitate robot positioning, ultra-wide band (UWB) base stations can be deployed in large scenes. A robot can measure distances based on UWB tags and surrounding base stations, and determine the positioning coordinates of the robot in the UWB coordinate system according to the coordinates of the base stations and the distances between the base stations and the robot.

After the map is built by the mapping device, the conversion relationship between the UWB coordinates and the map coordinate system can be calculated by manual calibration, so that a robot with low-cost sensors can position and navigate stably in the map by combining the wireless positioning information of the UWB tags.

However, in some large scenes, the map built by the mapping device may be deformed, and the UWB base station positioning may have slight deviations. As a result, when the conversion relationship is obtained by aligning the map coordinate system and the UWB coordinate system, the coordinate conversion error in some areas is large, and the coordinates cannot be effectively aligned, and the map cannot be accurately and effectively used for robot navigation.

Therefore, there is a need to provide a mapping method to overcome the above-mentioned problem.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic diagram of the implementation scene of a robot mapping method.

FIG. 2 is a schematic block diagram of a robot according to one embodiment.

FIG. 3 is an exemplary flowchart of a mapping method for a robot according to one embodiment.

FIG. 4 is a schematic diagram showing the screening of linear trajectories of the robot.

FIG. 5 is schematic block diagram of a map building device according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

A robot mapping algorithm usually includes two threads: front-end odometry and back-end loop closure optimization. The front-end generally uses lidar or visual sensors to calculate the odometer to estimate the pose of the robot, and record a key frame at a certain displacement or time interval. Sensor information and map pose data are stored in key frames. Backend optimization is a program that runs simultaneously with the frontend. The backend optimization program can check whether the historical key frames are in the same scene as the current key frame. If so, the current key frame and the historical key frames are established as displacement constraints, so that all key frames between the current key frame and the historical key frames become a loop, so as to optimize the loop, thereby optimizing and adjusting the poses of all key frames on the loop. After loop closure optimization, a current map is generated according to the poses of the new key frames.

However, in some large scenes, the map built by the mapping device may be deformed, and the UWB base station positioning may have slight deviations. As a result, when the conversion relationship is obtained by aligning the map coordinate system and the UWB coordinate system, the coordinate conversion error in some areas is large, and the coordinates cannot be effectively aligned. After the UWB positioning information in these areas is converted to the map coordinate system, the error is large and the UWB positioning information cannot be used for navigation.

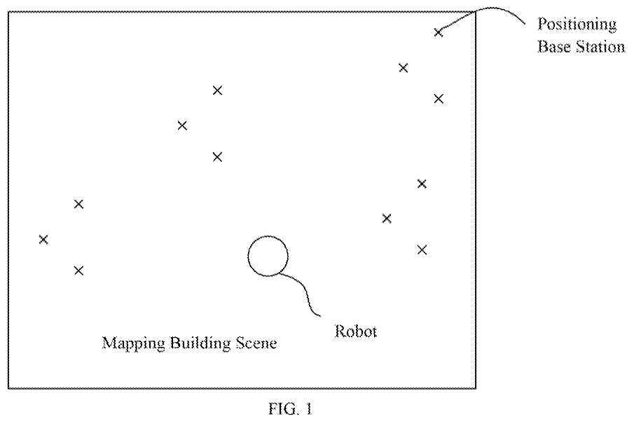

The embodiments of the present disclosure propose a mapping method for a robot in a large scene. FIG. 1 is a schematic diagram of the implementation scene of the robot mapping method. As shown in FIG. 1, the implementation scene is a large scene, in which multiple positioning base stations are arranged. The coordinates of each positioning base station in the positioning coordinate system can be obtained through the measurement of an electronic total station in advance. During the movement of the robot, the robot may pass by the areas where the positioning base stations are arranged. The positioning base stations can interact with the robot to obtain the positioning coordinates of the robot in the positioning coordinate system. When the robot is in the state of linear motion and the distance of the linear motion is large, the robot may obtain two or more positioning coordinates determined by different base stations during the same linear motion. When the distance that the robot travels during the linear motion is short, the robot may not be able to obtain the robot's mapping coordinates, or may only obtain a positioning coordinate determined by the same base station.

Here, two coordinate systems are used. One is the positioning coordinate system that is determined based on the positioning base stations in the operation scene of the robot. The other is the map coordinate system that is determined based on the starting position or other specific positions when the robot is building a map.

During the mapping process, the robot can collect environmental image information based on the main sensor of the robot. The main sensor may include one or more of a single-line lidar, a multi-line lidar, a monocular camera, a multiocular camera, or a depth camera.

The embodiments of the present disclosure will be described in detail below in conjunction with the accompanying drawings. In the case of no conflict, the following embodiments and features in the embodiments can be combined with each other.

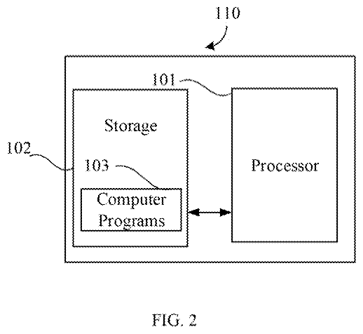

FIG. 2 shows a schematic block diagram of a robot 110 according to one embodiment. The robot 110 may be, but not limited to, a wheeled robot or a legged robot. In one embodiment, the robot 110 may include a processor 101, a storage 102, and one or more executable computer programs 103 that are stored in the storage 102.

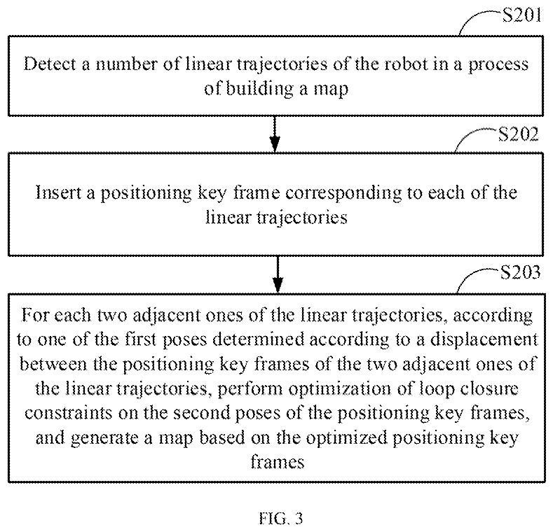

The storage 102 and the processor 101 are directly or indirectly electrically connected to each other to realize data transmission or interaction. For example, they can be electrically connected to each other through one or more communication buses or signal lines. The processor 101 performs corresponding operations by executing the executable computer programs 103 stored in the storage 102. When the processor 101 executes the computer programs 103, the steps in the embodiments of the mapping method, such as steps S201 to S203 in FIG. 3 are implemented.

The processor 101 may be an integrated circuit chip with signal processing capability. The processor 101 may be a central processing unit (CPU), a general-purpose processor, a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 101 can implement or execute the methods, steps, and logical blocks disclosed in the embodiments of the present disclosure.

The storage 102 may be, but not limited to, a random-access memory (RAM), a read only memory (ROM), a programmable read only memory (PROM), an erasable programmable read-only memory (EPROM), and an electrical erasable programmable read-only memory (EEPROM). The storage 102 may be an internal storage unit of the robot 110, such as a hard disk or a memory. The storage 102 may be an external storage device of the robot 110, such as a plug-in hard disk, a smart memory card (SMC), and a secure digital (SD) card, or any suitable flash cards. Furthermore, the storage 102 may include both an internal storage unit and an external storage device. The storage 102 is to store computer programs, other programs, and data required by the robot 110. The storage 102 can also be used to temporarily store data that have been output or is about to be output.

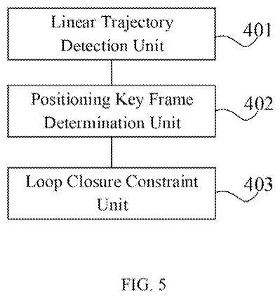

Exemplarily, the one or more computer programs 103 may be divided into one or more modules/units, and the one or more modules/units are stored in the storage 102 and executable by the processor 101. The one or more modules/units may be a series of computer program instruction segments capable of performing specific functions, and the instruction segments are used to describe the execution process of the one or more computer programs 103 in the robot 110. For example, the one or more computer programs 103 may be divided into a linear trajectory detection unit 401, a positioning key frame determination unit 402, and a loop closure constraint unit 403 as shown in FIG. 5.

It should be noted that the block diagram shown in FIG. 2 is only an example of the robot 110. The robot 110 may include more or fewer components than what is shown in FIG. 2, or have a different configuration than what is shown in FIG. 2. Each component shown in FIG. 2 may be implemented in hardware, software, or a combination thereof.

FIG. 3 is an exemplary flowchart of a mapping method for a robot according to one embodiment. As an example, but not a limitation, the method can be implemented by the robot 110. The method may include the following steps.

Step S201: Detect a number of linear trajectories of the robot in a process of building a map.

When the robot is a wheeled robot, the chassis of the robot is a wheeled chassis. The moving state of the robot can be monitored according to the speed of the odometer of the wheeled robot to determine whether the moving trajectory of the robot is a linear trajectory.

According to the collected odometer information, if the linear speed of the robot's current heading is greater than a predetermined speed threshold (e.g., 0), the speed of the odometer in other directions is 0 or less than a predetermined speed threshold, and the angular speed is 0 or less than a predetermined angular speed threshold, it is determined that the robot is in a state of linear motion. When the speed in other directions of the odometer is not 0 or greater than a predetermined speed threshold, or the angular speed is not 0 or greater than a predetermined angular speed threshold, it is determined that the robot ends the linear motion state.

The odometer may include one or more sensors. For example, the odometer may include one or more of a wheel encoder odometer, a laser radar odometer, a visual odometer, and an IMU odometer.

In another embodiment when the robot is a legged robot, it swings slightly in the left and right directions when the legged robot moves forward in a straight line, and the trajectory detected by the odometer will reflect the swing from side to side. Therefore, in order to accurately detect the linear trajectory of the legged robot, the content of the control commands from a monitoring system can be used to determine whether the content of the commands is to control the robot to walk along a linear trajectory. When it is monitored that a straight forward command is issued, the moment when the robot starts to move forward is determined as the starting point of the linear motion state. After receiving a command that is to stop the robot, the robot stops moving forward, which is determined as the end point of the robot's linear motion.

After the linear trajectories of the motion of the robot is determined, further screening of the linear trajectories can be performed.

During the mapping process, when the robot travels a small linear distance, the robot may not obtain the positioning coordinates in the positioning coordinate system or only obtain one positioning coordinate in the linear trajectory. In order to accurately locate the robot, linear trajectories with a linear movement distance less than a first distance threshold can be filtered out and determined as invalid linear trajectories. This enables the robot to obtain two or more positioning coordinates determined by the positioning base stations during the linear motion. The first distance threshold may be determined according to the size of the scene and the density of the positioning base stations. In one embodiment, the first distance threshold may be 4-8 meters.

In order to make the positioning coordinates (coordinates in the positioning coordinate system) in the two linear trajectories used for mapping optimization determined by different positioning base stations as much as possible, it may be set that the distance between the positioning coordinates of corresponding positions in the two linear trajectories is greater than a second distance threshold. For example, the distance between the initial positioning coordinates in the two linear trajectories is greater than the second distance threshold. The second distance threshold may be determined according to the size of the scene and the density of the positioning base stations. In one embodiment, the second distance threshold may be 20-50 meters.

The base stations used for robot positioning may include any one or more of UWB base stations, Bluetooth base stations, and WIFI base stations.

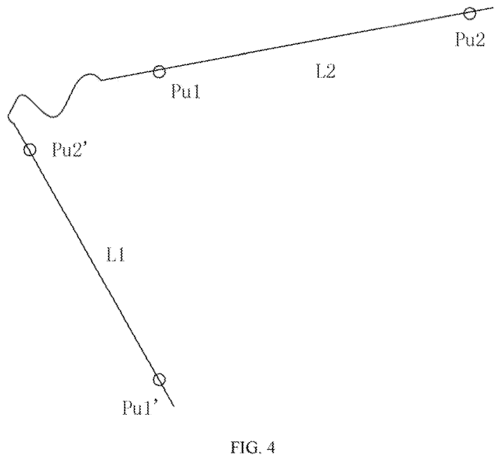

FIG. 4 is a schematic diagram showing the screening of linear trajectories of the robot. The robot starts from a static state, and when the robot receives a linear movement command or detects that the robot is in a linear motion state, and the length d1 from the first positioning point to the second positioning point of the linear trajectory L1 is greater than the first distance threshold, it is determined that the linear trajectory L1 of meets the preset length requirement. By positioning the base station for positioning detection, the first positioning point pu1′ of L1 can be determined by the positioning base station when the robot is at the beginning of the linear trajectory, and the second positioning point pu2′ of L1 can be determined by the positioning base station when the robot is at the end of the linear trajectory.

After the linear trajectory L1 ends, it is detected that the robot is in the linear motion state again, and the length d2 from the first positioning point to the second positioning point in the linear trajectory L2 is greater than the first distance threshold. The positioning base station can then determine the first positioning point pu1 of trajectory L2 when the trajectory L2 starts, and the positioning base station can determine the second positioning point pu2 of trajectory L2 when the trajectory L2 ends. The distance between corresponding positioning points in two adjacent linear trajectories can be calculated. For example, the distance pu1-pu1′ between the first positioning points in two adjacent linear trajectories, or the distance pu2-pu2′ between the second positioning points in two adjacent linear trajectories can be calculated. If the calculated distance pu1-pu1′ between the first positioning points or the distance pu2-pu2′ between the second positioning points is greater than the second distance threshold, then it is determined that the linear trajectory is a valid linear trajectory. Otherwise, it is determined that the linear trajectory is an invalid linear trajectory.

In one embodiment, the first positioning point may be a positioning point that is first detected by the positioning base station after the linear trajectory starts. The second positioning point is the last positioning point detected by the positioning base station before the end of the linear trajectory.

After the linear trajectory L2 is determined to be a valid linear trajectory, the linear trajectory can be used as the basis for subsequent linear trajectory calculations, and the linear trajectories can be further screened until the screening of all the linear trajectories in the robot travelling path is completed.

Step S202: Insert a positioning key frame corresponding to each of the linear trajectories.

The positioning key frame may include, when the robot is located on a corresponding one of the linear trajectories, a first pose in a positioning coordinate system, and a second pose in a map coordinate system.

In one embodiment, the positioning coordinate system is the coordinate system determined based on the positioning base stations, that is, the coordinate system determined when determining the preset coordinates of the positioning base stations. The map coordinate system is the coordinate system determined according to the collected map information when the robot constructs the map, and the origin of the map coordinate system can be the starting position of the robot when constructing the map.

In one embodiment, the positioning key frame may include a first pose of the robot in the positioning coordinate system and a second pose of the robot in the map coordinate system. The positioning key frame may further include a positioning key frame number, information of the main sensor for mapping, the length from the first positioning point to the second positioning point of the linear trajectory, and the like.

When determining the first pose, one of the positioning points of the linear trjectory (e.g., the coordinates of the second positioning point) can be used as the coordinates of the first pose, and the direction of the straight line can be used as the orientation of the first pose. For example, if the coordinates of the second positioning point are (pu2_x, pu2_y), and the coordinates of the first positioning point are (pu1_x, pu1_y), it can be determined that the orientation of the robot when it is at the second positioning point is: atan ((pu2_y−pu1_y)/(pu2_x−pu1_x)). Therefore, when the coordinates of the first pose in the key frame are determined by the coordinates of the second positioning point, the first pose can be expressed as (pu2_x, pu2_y, pu_theta), where pu_theta=atan((pu2_y−pu1_y)/(pu2_x−pu1_x)). The determined positioning key frames can be added to the map key frames in the mapping algorithm. The displacement between the current positioning key frame and the previous positioning key frame can be stored. For example, the displacement may be the length between the second positioning point pu2′ of the previous positioning key frame and the current second positioning point pu2.

Since the orientation of the robot is included in the first pose, and the orientation is determined based on a corresponding linear trajectory of the robot, the optimal calculation of loop closure constraints can be performed on the robot effectively based on the orientation of the robot.

The second pose of the robot in the map coordinate system can be determined based on the orientation information and displacement information of the main sensor of the robot.

In one embodiment, when the robot starts to build a map, the robot can be controlled to perform linear motion, so that the positioning key frames for loop closure constraint optimization can be obtained as soon as possible.

Step S203: For each two adjacent ones of the linear trajectories, according to one of the first poses determined according to a displacement between the positioning key frames of the two adjacent ones of the linear trajectories, perform optimization of loop closure constraints on the second poses of the positioning key frames, and generate a map based on the optimized positioning key frames.

In one embodiment, each linear trajectory may correspond to a positioning key frame. According to the first pose of the positioning key frame in the positioning coordinate system, the binding constraint relationship between two adjacent positioning key frames can be determined. That is, the binding constraint relationship between the current positioning key frame and the positioning key frame of the previous linear trajectory can be determined.

When the first pose of the robot is the pose determined by the last positioning point (i.e., the second positioning point) before the end of the linear trajectory of the robot, the length of between the corresponding positions of the two adjacent linear trajectories where the robot is located can be determined according to the first pose in the two adjacent linear trajectories. For example, if the first pose of the previous linear trajectory is (pu2_x′, pu2_y′, pu_theta′), and the first pose of the current linear trajectory is (pu2_x, pu2_y, pu_theta), the length between the first poses of two adjacent linear trajectories can be determined.

During the map building process, when the map building program performs optimization at the back end, after the number of positioning key frames is greater than 2, the nearest positioning key frame to the current positioning key frame can be searched. The nearest positioning key frame is a previous positioning key frame that can be used to establish binding constraints. After the nearest previous positioning key frame is found, the second pose (i.e., the position and orientation of the robot in the map coordinate system) when the robot moves from the position of the previous positioning key frame to the position of the current positioning key frame can be optimized according to the position error and angle error of the first pose of the current positioning key frame.

The position error of the first pose can be determined as Error_p according to a preset positioning accuracy error Error_p. When determining the orientation of the first pose in the positioning key frame, the orientation may be determined according to the coordinates of the first positioning point and the second positioning point in the positioning coordinate system in the linear trajectory corresponding to the positioning key frame. Therefore, the angle error of the first pose can be calculated based on the distance d2 between the first positioning point and the second positioning point and the determined position error of the first pose. For example, based on the length d2 from the first positioning point to the second positioning point, the angle error of the heading can be calculated as: Error_a=atan(Error_p/d2). Based on the determined position error and angle error, optimization of loop closure constraints can be performed on the pose of the map key frame corresponding to the positioning key frame. The map key frame includes the pose of the robot in the map coordinate system, and each positioning key frame corresponds to a map keyframe. The optimization of loop closure constraints may include optimization on the second pose of the map key frame corresponding to the positioning key frame. For example, loop closure constraints and optimization can be performed on the position and orientation of the robot in the map keyframe in map coordinate system.

In one embodiment, the robot can obtain map key frames at predetermined time intervals or displacement intervals. The robot can determine the positioning key frames during the robot's movement process based on the collected linear trajectory. When determining the positioning key frames of the robot, corresponding map key frames can be generated. When two adjacent positioning key frames are detected, the positioning range of the first pose can be determined based on the displacement of the first pose in the adjacent two positioning key frames, combined with a predetermined positioning accuracy. Based on the positioning range, positioning optimization can be performed on the map key frame between the first poses of the current linear trajectory and the previous linear trajectory.

The angle error Error_a of the orientation of the first pose can be determined by Error_a=atan(Error_p/d2) based on the orientation in the first pose determined based on the linear trajectory and the length from the first positioning point to the second positioning point. Error_p is the position error of the first pose, and d2 is the length from the first positioning point to the second positioning point in the linear trajectory.

After the position error and angle error of the robot at the position corresponding to the positioning key frame of the linear trajectory are determined through the positioning coordinate system, when the robot moves from the position of the previous positioning key frame to the position of the current positioning key frame, optimization of loop closure can be performed on the second pose of the robot (i.e., the map key frame) based on the position, position error, orientation and angle error of the current positioning key frame.

While the map is built, optimized calculation of loop closure constraints can be performed on the map key frame collected by the main sensor based on the position information and orientation angle information determined by the positioning base stations in the positioning coordinate system, to obtain the optimized map key frame.

During acquisition, the read map key frames with previously stored map key frames can be compared. If they match with each other, an image-based loop closure constraint is established, and optimization of loop closure is performed on all map key frames in the loop, and the recorded poses of the map key frames and the map keyframes are updated.

In one embodiment, while the map is built, the angular accuracy Error_a when the robot is in the first pose can be obtained based on the position accuracy Error_p of the two linear trajectories determined by the positioning information of the positioning base stations, and the distance d2 between the first positioning point and the second positioning point based on the linear trajectory. For example, angular accuracy can be expressed as: Error_a=atan(Error_p/d2). Based on the orientation of the first pose determined by the linear trajectory, the calculation of the loop closure constraints can be performed accurately for the robot.

It should be understood that sequence numbers of the foregoing processes do not mean an execution sequence in this embodiment of the present disclosure. The execution sequence of the processes should be determined according to functions and internal logic of the processes, and should not be construed as any limitation on the implementation processes of the embodiment of the present disclosure.

By implementing the above-mentioned mapping method, the robot can be aligned during the process of building the map, avoiding the trouble of first building the map and then aligning. Based on the positioning key frames determined by the linear trajectories, optimization of loop closure constraints can be performed on the second poses according to the first poses of the two positioning key frames, which can effectively reduce the angle error of the positioning key frames, thereby improving the accuracy of the robot navigation map.

Referring to FIG. 5, in one embodiment, a robot mapping device may include a linear trajectory detection unit 401, a positioning key frame determination unit 402, and a loop closure constraint unit 403. The linear trajectory detection unit 401 is to detect a number of linear trajectories of the robot in a process of building a map. The positioning key frame determination unit 402 is to insert a positioning key frame corresponding to each of the linear trajectories. The positioning key frame may include, when the robot is located on a corresponding one of the linear trajectories, a first pose in a positioning coordinate system, and a second pose in a map coordinate system. The loop closure constraint unit 403 is to, for each two adjacent ones of the linear trajectories, according to one of the first poses determined according to a displacement between the positioning key frames of the two adjacent ones of the linear trajectories, perform optimization of loop closure constraints on the second poses of the positioning key frames, and generate a map based on the optimized positioning key frames.

It can be understood that the device in the embodiments above corresponds to the method in the embodiments above. The basic principles and technical effects of the device are the same as the aforementioned method. For a brief description, for parts not mentioned in this device embodiment, reference can be made to corresponding description in the method embodiments.

It should be noted that content such as information exchange between the modules/units and the execution processes thereof is based on the same idea as the method embodiments of the present disclosure, and produces the same technical effects as the method embodiments of the present disclosure. For the specific content, refer to the foregoing description in the method embodiments of the present disclosure. Details are not described herein again.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may be indirect coupling or communication connection through some interfaces, devices or units, and may be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented mapping method for a robot, the method comprising:
detecting a plurality of linear trajectories of the robot in a process of building a map;
inserting a positioning key frame corresponding to each of the linear trajectories, wherein the positioning key frame comprises, when the robot is located on a corresponding one of the linear trajectories, a first pose in a positioning coordinate system, and a second pose in a map coordinate system; and
for each two adjacent ones of the linear trajectories, according to one of the first poses determined according to a displacement between the positioning key frames of the two adjacent ones of the linear trajectories, performing optimization of loop closure constraints on the second poses of the positioning key frames, and generating a map based on the optimized positioning key frames.

2. The method of claim 1, wherein inserting the positioning key frame corresponding to each of the linear trajectories comprises:
obtaining a first locating point that is detected first after each of the linear trajectory begins, and a last, second locating point detected before the linear trajectory ends;
determining an orientation of the first pose of the positioning key frame according to the coordinates of the first positioning point and the second positioning point in the positioning coordinate system; and
using a position of the second positioning point in the positioning coordinate system as coordinates of the first pose of the positioning key frame.

3. The method of claim 1, further comprising, before inserting the positioning key frame corresponding to each of the linear trajectories,
determining a first locating point that is detected first after each of the linear trajectory begins, and a last, second locating point detected before the linear trajectory ends; and
determining that a current trajectory of the robot is a valid linear trajectory in response to a distance between the first locating point and the second locating point being greater than a first distance threshold.

4. The method of claim 3, wherein detecting the plurality of linear trajectories of the robot in the process of building the map comprises:
in response to the robot being a wheeled robot, determining whether the robot is in a linear motion state according to detection information of an odometer; and
in response to the robot being a wheeled robot, determining whether the robot is in a linear motion state control instructions received by the robot.

5. The method of claim 3, further comprising, before determining that the current trajectory of the robot is a valid linear trajectory,
determining that a distance between the second positioning point of a current linear trajectory and the second positioning point of a previous linear trajectory is greater than a second distance threshold.

6. The method of claim 1, further comprising, before generating the map based on the optimized positioning key frames,
performing loop closure detection according to images detected by a main sensor in the process of building the map; and
performing optimization of loop closure on key frames of the map determined by the main sensor according to the loop closure constraints detected by the main sensor;
wherein generating the map based on the optimized positioning key frames comprises: generating the map based on the optimized positioning key frames and the key frames of the map.

7. The method of claim 1, wherein performing optimization of loop closure constraints on the second poses of the positioning key frames comprises:
for each two adjacent ones of the linear trajectories, determining position errors of the first poses of the positioning key frames of the two adjacent ones of the linear trajectories according to a preset positioning accuracy;
determining angle errors of the first poses according to the positioning accuracy and the length from a first positioning point to a second positioning point in each of the two adjacent ones of the linear trajectories; and
performing optimization of loop closure constraints on the second poses of the positioning key frames according to the position errors and the angle errors.

8. A robot comprising:
one or more processors; and
a memory coupled to the one or more processors, the memory storing programs that, when executed by the one or more processors, cause performance of operations comprising:
detecting a plurality of linear trajectories of the robot in a process of building a map;
inserting a positioning key frame corresponding to each of the linear trajectories, wherein the positioning key frame comprises, when the robot is located on a corresponding one of the linear trajectories, a first pose in a positioning coordinate system, and a second pose in a map coordinate system; and
for each two adjacent ones of the linear trajectories, according to one of the first poses determined according to a displacement between the positioning key frames of the two adjacent ones of the linear trajectories, performing optimization of loop closure constraints on the second poses of the positioning key frames, and generating a map based on the optimized positioning key frames.

9. The robot of claim 8, wherein inserting the positioning key frame corresponding to each of the linear trajectories comprises:
obtaining a first locating point that is detected first after each of the linear trajectory begins, and a last, second locating point detected before the linear trajectory ends;
determining an orientation of the first pose of the positioning key frame according to the coordinates of the first positioning point and the second positioning point in the positioning coordinate system; and
using a position of the second positioning point in the positioning coordinate system as coordinates of the first pose of the positioning key frame.

10. The robot of claim 8, wherein the operations further comprise, before inserting the positioning key frame corresponding to each of the linear trajectories,
determining a first locating point that is detected first after each of the linear trajectory begins, and a last, second locating point detected before the linear trajectory ends; and
determining that a current trajectory of the robot is a valid linear trajectory in response to a distance between the first locating point and the second locating point being greater than a first distance threshold.

11. The robot of claim 10, wherein detecting the plurality of linear trajectories of the robot in the process of building the map comprises:
in response to the robot being a wheeled robot, determining whether the robot is in a linear motion state according to detection information of an odometer; and
in response to the robot being a wheeled robot, determining whether the robot is in a linear motion state control instructions received by the robot.

12. The robot of claim 10, wherein the operations further comprise, before determining that the current trajectory of the robot is a valid linear trajectory,
determining that a distance between the second positioning point of a current linear trajectory and the second positioning point of a previous linear trajectory is greater than a second distance threshold.

13. The robot of claim 8, wherein the operations further comprise, before generating the map based on the optimized positioning key frames,
performing loop closure detection according to images detected by a main sensor in the process of building the map; and
performing optimization of loop closure on key frames of the map determined by the main sensor according to the loop closure constraints detected by the main sensor;
wherein generating the map based on the optimized positioning key frames comprises: generating the map based on the optimized positioning key frames and the key frames of the map.

14. The robot of claim 8, wherein performing optimization of loop closure constraints on the second poses of the positioning key frames comprises:
for each two adjacent ones of the linear trajectories, determining position errors of the first poses of the positioning key frames of the two adjacent ones of the linear trajectories according to a preset positioning accuracy;
determining angle errors of the first poses according to the positioning accuracy and the length from a first positioning point to a second positioning point in each of the two adjacent ones of the linear trajectories; and
performing optimization of loop closure constraints on the second poses of the positioning key frames according to the position errors and the angle errors.

15. A non-transitory computer-readable storage medium storing instructions that, when executed by at least one processor of a robot, cause the at least one processor to perform a method, the method comprising:
detecting a plurality of linear trajectories of the robot in a process of building a map;
inserting a positioning key frame corresponding to each of the linear trajectories, wherein the positioning key frame comprises, when the robot is located on a corresponding one of the linear trajectories, a first pose in a positioning coordinate system, and a second pose in a map coordinate system; and
for each two adjacent ones of the linear trajectories, according to one of the first poses determined according to a displacement between the positioning key frames of the two adjacent ones of the linear trajectories, performing optimization of loop closure constraints on the second poses of the positioning key frames, and generating a map based on the optimized positioning key frames.

16. The non-transitory computer-readable storage medium of claim 15, wherein inserting the positioning key frame corresponding to each of the linear trajectories comprises:
obtaining a first locating point that is detected first after each of the linear trajectory begins, and a last, second locating point detected before the linear trajectory ends;
determining an orientation of the first pose of the positioning key frame according to the coordinates of the first positioning point and the second positioning point in the positioning coordinate system; and
using a position of the second positioning point in the positioning coordinate system as coordinates of the first pose of the positioning key frame.

17. The non-transitory computer-readable storage medium of claim 15, wherein the method further comprises, before inserting the positioning key frame corresponding to each of the linear trajectories,
determining a first locating point that is detected first after each of the linear trajectory begins, and a last, second locating point detected before the linear trajectory ends; and
determining that a current trajectory of the robot is a valid linear trajectory in response to a distance between the first locating point and the second locating point being greater than a first distance threshold.

18. The non-transitory computer-readable storage medium of claim 17, wherein detecting the plurality of linear trajectories of the robot in the process of building the map comprises:
in response to the robot being a wheeled robot, determining whether the robot is in a linear motion state according to detection information of an odometer; and
in response to the robot being a wheeled robot, determining whether the robot is in a linear motion state control instructions received by the robot.

19. The non-transitory computer-readable storage medium of claim 17, wherein the method further comprises, before determining that the current trajectory of the robot is a valid linear trajectory,
determining that a distance between the second positioning point of a current linear trajectory and the second positioning point of a previous linear trajectory is greater than a second distance threshold.

20. The non-transitory computer-readable storage medium of claim 15, wherein the method further comprises, before generating the map based on the optimized positioning key frames,
performing loop closure detection according to images detected by a main sensor in the process of building the map; and
performing optimization of loop closure on key frames of the map determined by the main sensor according to the loop closure constraints detected by the main sensor;
wherein generating the map based on the optimized positioning key frames comprises: generating the map based on the optimized positioning key frames and the key frames of the map.
